(19) United States
(12) Patent Application Publication
(10) Pub. No.: US 2006/0228462 A1
(43) Pub. Date: Oct. 12, 2006

(54) Processes for making functional soy protein isolate compositions

(76) Inventor: Zahid Mozaffar, Ballwin, MO (US)

Correspondence Address: SOLAE, LLC, PO BOX 88940, ST LOUIS, MO, 63188, US

(21) Appl. No.: 11/099,798

(22) Filed: Apr. 6, 2005

(51) Int. Cl. A23J 1/00

(52) U.S. Cl. 426/656

(57) ABSTRACT

Processes for producing soy protein isolate compositions having improved functionality are disclosed. Specifically, the processes comprise modifying a precipitated soy protein curd with a modifying agent selected from the group consisting of transglutaminase, sodium hypochlorite, a sucrose ester, a fatty acid, a lecithin and combinations thereof. The soy protein isolate compositions are suitable for use in meat and meat products.

### BACKGROUND OF THE INVENTION

The present invention generally relates to a soy protein isolate composition having improved functionality for use in meat products and processes for making such soy protein isolate compositions. More particularly, the present invention relates to soy protein isolate compositions having improved gel-strength, emulsion strength, and emulsion stability when used in meat products.

Plant protein materials are used as functional food ingredients, and have numerous applications in enhancing desirable characteristics in food products. In particular, because of their high protein content and low oligosaccharide/carbohydrate content, soy protein products are some of the most commonly used functional food ingredients. For example, soy protein materials can be used as emulsifiers in meats, such as hot dogs, to bind the meat and give the meat a good texture and firm bite. Another common application for soy protein materials as functional food ingredients is in creamed soups, gravies, and yogurts, where the soy protein material acts as a thickening agent and provides a creamy viscosity to the food product.

Suitable soy protein materials for use in food products include soy flakes, soy flour, soy grits, soy meal, soy protein concentrates, soy protein isolates, and mixtures thereof. The primary difference between these soy protein materials is the degree of refinement relative to whole soybeans.

Soy flakes are generally produced by dehulling, defatting, and grinding the soybean and typically contain less than about 65% (by weight) soy protein on a moisture-free basis. Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as Bowman-Birk and Kunitz trypsin inhibitors. Heat treating the ground flakes in the presence of significant amounts of water is avoided to prevent denaturation of the soy protein in the material and to avoid costs involved in the addition and removal of water from the soy material. The resulting ground, heat treated material is a soy flour, soy grit, or a soy meal, depending on the average particle size of the material. Soy flour generally has a particle size of less than about 150 μm. Soy grits generally have a particle size of about 150 to about 1000 μm. Soy meal generally has a particle size of greater than about 1000 μm.

Soy protein concentrates typically contain about 65% (by weight) to about 85% (by weight) soy protein, with the major non-protein component being fiber. Soy protein concentrates are typically formed from defatted soy flakes by washing the flakes with either an aqueous alcohol solution or an acidic aqueous solution to remove the soluble carbohydrates from the protein and fiber.

Soy protein isolates, which are more highly refined soy protein materials, are processed to contain at least 90% (by weight) soy protein on a moisture free basis and little or no soluble carbohydrates or fiber. Soy protein isolates are typically formed by extracting soy protein and water soluble carbohydrates from defatted soy flakes or soy flour with an alkaline aqueous extractant. The aqueous extract, along with the soluble protein and soluble carbohydrates, is separated from materials that are insoluble in the extract, mainly fiber. The extract is typically then treated with an acid to adjust the pH of the extract to the isoelectric point of the protein to precipitate the protein from the extract. The precipitated protein is separated from the extract, which retains the soluble carbohydrates, and is dried after an optional pH adjustment step.

Soy protein concentrates and soy protein isolates are particularly effective functional food ingredients due to the versatility of soy protein and the relatively high content thereof in soy protein concentrates and isolates. Additionally, the lack of raffinose and stachyose oligosaccharides, which naturally occur in soybeans, is advantageous. Humans lack the α-galactosidase enzyme needed to break down and digest complex oligosaccharides such as raffinose and stachyose into simple carbohydrates such as glucose, fructose, and sucrose, which can be easily absorbed by the gut. Instead of being absorbed, soy raffinose and stachyose enter the lower intestine where they are fermented by bacteria to cause intestinal gas and flatus.

There have been many attempts to use soy protein concentrates and isolates as ingredients to improve the functionality of food products. See generally, U.S. Pat. Nos. 6,465,037, 6,423,364, and 6,355,2595, issued to Altemueller, et al. However, it has been found that these food ingredients may not always be effective in improving the functionality of food products in a salty environment, such as that in some commercially available meats and meat products. Specifically, most commercially available meats and meat products contain about 2% salt (by weight of the product).

As such, a need exists in the industry for a soy protein isolate composition having improved functionality, and specifically, gel strength, emulsion strength, and emulsion stability. Additionally, it would be advantageous if the soy protein isolate composition is capable of improving functionality in environments comprising salt, such as commercially available meats and meat products.

### SUMMARY OF THE INVENTION

In one embodiment, the present invention provides processes for producing soy protein isolate compositions for use in food products such as meats and meat products. These compositions provide the meat or meat products with improved functionality, specifically, gel strength, emulsion strength, and emulsion stability, even in an environment comprising salt. The processes include treatment of a precipitated soy protein curd with a modifying agent selected from the group consisting of transglutaminase, sodium hypochlorite, a sucrose ester, a fatty acid, a lecithin, and combinations thereof.

As such, the present invention is directed to a process for producing soy protein isolate compositions. The process comprises extracting soy protein from soy flakes with an aqueous alkaline wash having a pH of from 8.5 to about 10; suspending the extracted soy protein in a wash solution comprising water; contacting the suspended soy protein with an acid to form a precipitated soy protein curd; contacting the precipitated soy protein curd with a hydrating solution comprising water to form a precipitated soy protein curd suspension; contacting the precipitated soy protein curd suspension with a basic solution to form a neutralized soy protein curd suspension; introducing a modifying agent into the neutralized soy protein curd suspension to form a modified soy protein curd suspension; heating the modified soy protein curd suspension; and drying the heated modified soy protein curd suspension to form a soy protein isolate composition. The modifying agent is selected from the group consisting of transglutaminase, sodium hypochlorite, a sucrose ester, a fatty acid, a lecithin, and combinations thereof.

The present invention is further directed to a process of producing a soy protein isolate composition. The process comprises extracting soy protein from soy flakes with an aqueous alkaline wash having a pH of from 8.5 to about 10; suspending the extracted soy protein in a wash solution comprising water; contacting the suspended soy protein with an acid to form a precipitated soy protein curd; contacting the precipitated soy protein curd with a hydrating solution comprising water to form a precipitated soy protein curd suspension; contacting the precipitated soy protein curd suspension with a basic solution to form a neutralized soy protein curd suspension; heating the neutralized soy protein curd suspension; introducing a modifying agent into the heated neutralized soy protein curd suspension to form a heated modified soy protein curd suspension; and drying the heated modified soy protein curd suspension to form a soy protein isolate composition. The modifying agent is selected from the group consisting of sodium hypochlorite, transglutaminase, a sucrose ester, a fatty acid, a lecithin, and combinations thereof.

Other features and advantages of this invention will be in part apparent and in part pointed out hereinafter.

### DETAILED DESCRIPTION OF THE PREFERRED EMBODIMENTS

The present invention is generally directed to processes for producing soy protein isolate compositions. Specifically, the present invention relates to producing a soy protein isolate composition by chemically modifying a precipitated soy protein curd with a modifying agent. As used herein, “precipitated soy protein curd” means soy protein that has been through several steps of processing, including extraction, suspension in water, and precipitation in an acid solution (i.e., an aqueous solution having a pH of less than 7.0). The compositions have improved functionality and are suitable for use in meats and meat products. Specifically, the compositions have improved gel strength, emulsion strength, and emulsion stability.

In one embodiment, the process for producing a soy protein isolate composition comprises a number of steps including: (1) extracting soy protein from soy flakes with an aqueous alkaline wash having a pH of from 8.5 to about 10; (2) suspending the extracted soy protein in a wash solution comprising water; (3) contacting the suspended soy protein with an acid to form a precipitated soy protein curd; (4) contacting the precipitated soy protein curd with a hydrating solution comprising water to form a precipitated soy protein curd suspension; (5) contacting the precipitated soy protein curd suspension with a basic solution to form a neutralized soy protein curd suspension; (6) introducing a modifying agent to the neutralized soy protein curd suspension to form a modified soy protein curd suspension; (7) heating the modified soy protein curd suspension; and (8) drying the heated modified soy protein curd suspension to form a soy protein isolate composition.

A soy protein curd suitable for use in the processes of the present invention can be obtained by processing a soy protein source, such as soy flakes, by an extraction process using an aqueous alkaline wash. Extraction processes for forming soy protein curds are well known and disclosed, for example, in U.S. Pat. No. 6,313,273, issued to Thomas, et al. (Nov. 6, 2001) and U.S. Pat. No. 6,830,773, issued to Porter, et al. (Dec. 14, 2004).

One process suitable for preparing a precipitated soy protein curd for modification in the processes described herein includes cracking soybeans to remove the hull, rolling them into flakes with flaking machines, defatting the flakes with hexane or heptane, subjecting the flakes to an aqueous extraction process, suspending the extracted soy protein in a wash solution, and precipitating a soy protein curd therefrom. Suitable flaking machines may consist of a pair of horizontal counter-rotating smooth steel rolls. The rolls are pressed one against the other by means of heavy springs or by controlled hydraulic systems. The soybeans are fed between the rolls and are flattened as the rolls rotate one against the other. The roll-to-roll pressure can be regulated to determine the average thickness of the flakes. The rolling process disrupts the oil cell, facilitating solvent extraction (i.e., hexane or heptane) of the oil. Specifically, flaking increases the contact surface between the oilseed tissues and the extractant, and reduces the distance that the extractant and the extract will have to travel in the extraction process as described herein below. Typical values for flake thickness are in the range of 0.2 to 0.35 millimeters.

The defatted soy flake material may then be put through an aqueous extraction process. Typically, the aqueous extraction process is an aqueous alkaline wash. The aqueous alkaline wash removes materials soluble therein, including a substantial portion of the isoflavones and carbohydrates. This produces a protein material that contains at least about 90% protein by weight on a dry basis, but which is significantly reduced in isoflavone concentration.

Typically, the alkaline wash has a pH of from 8.5 to about 10. The extraction is generally conducted by contacting the defatted soy flakes with an aqueous solution containing a set amount of base, such as sodium hydroxide, potassium hydroxide, ammonium hydroxide and/or calcium hydroxide, and allowing the pH to slowly decrease as the base is neutralized by substances extracted out of the solid soy flakes. The initial amount of base is typically chosen so that at the end of the extraction operation the extract has a desired pH value, e.g., a pH within the range of from 8.5 to about 9.5. Alternatively, the pH of the aqueous phase can be monitored (continuously or at periodic time intervals) during the extraction and base can be added as needed to maintain the pH at a desired value.

Desirably, the aqueous alkaline wash should be a food grade reagent. The defatted soy flake material should be contacted with sufficient wash solution to form a soy protein extract. The weight ratio of wash solution to defatted soy flake material may be from about 2:1 to about 20:1, and preferably is from about 5:1 to about 10:1. Preferably the defatted soy flake material is agitated in the wash solution and then centrifuged for a period of time to facilitate removal of materials soluble in the wash solution from the soy flake material. The wash solution is then decanted from the defatted soy flake material to provide a soy protein extract. The wash solution is recirculated through the extractor until the residual oil content in the soy flakes is reduced to the desired level. The above described aqueous alkaline wash extraction removes water soluble components of the soy protein-containing material, such as carbohydrates and fat.

Once the soy protein has been extracted, it is suspended in a wash solution. Typically, the wash solution comprises water having a temperature of from about 90° F. to about 100° F. (32-38° C.). In a suitable embidiment, the extracted soy protein is suspended for 10 minutes at a temperature of 96° F. (35.6° C.). This water wash suspension further removes water soluble components of the extracted soy protein.

Finally, the suspended soy protein is precipitated with an acid to form a precipitated soy protein curd. Precipitation separates remaining impurities, such as carbohydrates and fats, from the soy protein curd. In one embodiment, to allow for sufficient precipitation, the acid is contacted with the suspended soy protein for a time period of about 5 minutes. Typically, the precipitation of the soy protein curd is done at or near the isoelectric point og the soy proteins; that is, precipitation at a pH of from about 4.0 to about 5.0, preferably about 4.5. Suitable acids for precipitation can include, for example, hydrochloric acid, citric acid, phosphoric acid, and other organic and inorganic acids.

The above extraction, suspension, and precipitation steps can optionally be repeated one or more time to further remove impurities, such as carbohydrates and fat, from the precipitated soy protein curd.

Typically, the soy protein isolate compositions of the present invention comprise from about 98.5% (by weight dry basis) to about 99.75% (by weight dry basis) precipitated soy protein curd. The amount of precipitated soy protein curd in the soy protein isolate compositions of the present invention depends on the type and amount of modifying agent present in the compositions in combination with the precipitated soy protein curd, as discussed below.

In order to impart the desired level of soy protein into the soy protein isolate composition described herein, suitable precipitated soy protein curds comprise at least about 90% (by weight curd) soy protein. More suitably, the precipitated soy protein curd comprises from about 90% (by weight curd) to about 95% (by weight curd) soy protein.

In addition to the soy protein, the total protein concentration in the precipitated soy protein curd is also comprised of wheat gluten. Gluten is defined generally as a protein substance that remains when starch is removed from cereal grains, such as wheat, rye, and oat grains. Wheat gluten is gluten prepared from wheat. Wheat gluten provides for a chewy, elastic, or spongy texture in a finished food product, thereby imitating the texture of meat.

In addition to the soy protein and wheat gluten that comprise the total amount of protein in the precipitated soy protein curd, the precipitated soy protein curd (in dry basis) generally comprises less than 1.0% (by weight curd) carbohydrates, from about 0.2% (by weight curd) to about 1.0% (by weight curd) fat, less than 5.0% (by weight curd) ash, and from about 3.0% (by weight curd) to about 6.0% (by weight curd) moisture.

After sufficient extraction and precipitation, the precipitated soy protein curd is typically contacted with a hydrating solution comprising water to form a precipitated soy protein curd suspension. As used herein, the term “hydrating” refers to a static or dynamic soaking of the precipitated soy protein curd to introduce water therein. Typically, the precipitated soy protein curd is contacted with the hydrating solution for about 5 minutes. Suitably, hydration occurs by contacting the precipitated soy protein curd with a sufficient amount of hydrating solution comprising water.

After the precipitated soy protein curd has been sufficiently hydrated, the precipitated soy protein curd suspension is contacted with a basic solution, such as a sodium hydroxide solution, or another suitable basic solution to form a neutralized soy protein curd suspension. The neutralized soy protein curd suspension has an increased pH; that is, a pH greater than about 4.5. Typically, the precipitated soy protein curd suspension should be contacted with enough basic solution to raise the pH of the neutralized soy protein curd suspension to a pH of from about 6.5 to about 8.0, preferably about 6.75. Increasing the pH of the neutralized precipitated soy protein curd suspension is desirable as it has been found that soy protein isolate compositions processed at a higher pH have improved functionality in food products, such as meats.

Once the neutralized soy protein curd suspension is formed, a modifying agent is introduced into the neutralized soy protein curd suspension to modify the soy protein contained therein. Typically, the modifying agent is introduced into the neutralized soy protein curd suspension for a time period of from about 15 minutes to about 30 minutes. In one embodiment, the modifying agent is introduced into the neutralized soy protein curd suspension immediately after the pH of the precipitated soy protein curd suspension is raised by being contacted with the basic solution and prior to heating the suspension as discussed herein below. In another embodiment, the modifying agent is introduced into the neutralized soy protein curd suspension after the neutralized soy protein curd suspension is heated, as described below.

Generally, the modifying agents are capable of interacting with and improving the functionality of the soy proteins contained in the soy protein curd suspension. Specifically, the modifying agents can improve the gel strength, emulsion stability, emulsion strength, and/or solubility of the soy protein isolate compositions.

Some of the modifying agents suitable for use in the processes described herein, such as sucrose esters and lecithins as described below, can be characterized in terms of their hydrophilic/lipophilic balance (HLB). HLB is an empirical number that describes the relationship between the hydrophilic or water-soluble and lipophilic or oil-soluble portions of a molecule. Oil-soluble molecules have low HLB numbers and water-soluble molecules have high HLB numbers. HLB can be calculated based on the chemical structure using techniques well known to those skilled in the art. The HLB of the modifying agents used in the present invention suitably falls within the range of from about 2 to about 16, more suitably from about 4 to about 10. Even more suitably, the modifying agents used in the present invention have an HLB value of from about 4 to about 7.

The soy protein isolate compositions produced by the processes of the present invention typically comprise from about 0.25% (by weight dry basis) to about 1.5% (by weight dry basis) modifying agent. To obtain these amounts in the soy protein isolate compositions, the processes of the present invention typically comprise introducing from about 0.25% (by weight dry basis soy protein curd) to about 1.5% (by weight dry basis soy protein curd) modifying agent into the neutralized soy protein curd suspension. As such, for most of the modifying agents used in the present invention, there is no substantial loss of the modifying agent during modification, the heat treatment, or drying steps of the processes of the present invention. One exception is when the modifying agent is sodium hypochlorite. Sodium hypochlorite, as discussed below, modifies the soy protein structure to improve functionality. During this modification process, the sodium hypochlorite is depleted and the resulting soy protein isolate composition does not comprise sodium hypochlorite. As such, while the processes of the present invention comprise introducing from about 0.25% (by weight dry basis soy protein curd) to about 1.5% (by weight dry basis soy protein curd) sodium hypochlorite, the resulting soy protein isolate composition does not comprise sodium hypochlorite. Other suitable modifying agents for introduction into the neutralized precipitated soy protein curd suspension include transglutaminase, sucrose esters, fatty acids, lecithins, and combinations thereof.

In one embodiment, the modifying agent to be introduced into the neutralized soy protein curd suspension is transglutaminase (TG) (EC 2.3.2.13). Transglutaminases (TGs) are a family of enzymes that catalyze the acyl-transfer reactions between γ-carboxyamide groups of glutamine residues and the ε-amino group of lysines in proteins, leading to inter- or intramolecular cross-linking. Specifically, TGs form isopeptide bonds between glutamine and lysine residues in proteins, resulting in the formation of high molecular weight polymers. The use of transglutaminase in meat products have shown improvements in protein functionality, specifically improving gel strength, solubility, and emulsifying capacity. Furthermore, transglutaminase can increase viscosity and water holding capacity in food products.

When using transglutaminase as the modifying agent, it is typically preferred to inactivate the enzyme prior to drying the soy protein isolate composition as described herein below. When using transglutaminase as the modifying agent, it is typically preferred to inactivate the enzyme prior to drying the soy protein isolate composition as described herein below. The transglutaminase is inactivated to avoid any later reactions between the transglutaminase and the food products comprising the soy protein isolate compositions. Generally, the transglutaminase can be inactivated by steaming the soy protein isolate composition at a temperature of about 100° C. for about 5 minutes.

Typically, when the modifying agent is transglutaminase, from about 0.25% (by weight dry basis soy protein curd) to about 1.5% (by weight dry basis soy protein curd) transglutaminase is introduced into the neutralized soy protein curd suspension. More suitably, from about 0.3% (by weight dry basis soy protein curd) to about 0.4% (by weight dry basis soy protein curd) transglutaminase is introduced into the neutralized soy protein curd suspension. Although transglutaminase can be used alone as a modifying agent, it is desirably used in combination with a sucrose ester, a fatty acid, or a lecithin.

Alternatively, the modifying agent in the processes of the present invention can be a sucrose ester. Sucrose esters have conventionally been used in foods and food products to improve elasticity and juiciness. When used in the processes of the present invention, sucrose esters have now been found to improve the gel strength and texture of the soy protein isolate compositions.

Suitable sucrose esters for use in the processes of the present invention include sucrose esters comprising a fatty acid selected from the group consisting of stearic acid, palmitic acid, and lauric acid. For example, suitable sucrose esters include DK ESTER F-10, DK ESTER F-20, DK ESTER F-50, DK ESTER F-70, DK ESTER F-90, DK ESTER F-110, DK ESTER F-140, and DK ESTER F-160, all commercially available from Dai-Ichi Kogyo Seiyaku Co., Ltd. (Tokyo, Japan). Also suitable for the present invention are RYOTO ESTERS L-595, LWA-1570, L-1695, P-1670, and S-1570, which are commercially available from Mitsubishi-Kagaku Foods Corporation (Tokyo, Japan).

Typically, when the modifying agent is a sucrose ester, from about 0.25% (by weight dry basis soy protein curd) to about 1.5% (by weight dry basis soy protein curd) sucrose ester is introduced into the neutralized soy protein curd suspension. More suitably, from about 0.5% (by weight dry basis soy protein curd) to about 1.5% (by weight dry basis soy protein curd) sucrose ester is introduced into the neutralized soy protein curd suspension, and even more suitably, about 1.0% (by weight dry basis soy protein curd) sucrose ester is introduced into the neutralized soy protein curd suspension.

In another embodiment, the modifying agent for use in the processes of the present invention is a fatty acid or an alkali metal salt of a fatty acid. The alkali metal is either sodium or potassium. Fatty acids are valuable for use in foods and food products for their structural, textural, and stability properties. Specifically, fatty acids have been shown to improve gel strength and translucency. Suitable fatty acids and alkali metal salts of fatty acids include C₈-C₁₈ fatty acids, for example, caprylic acid, capric acid, lauric acid, sodium laurate, myristic acid, palmitic acid, stearic acid, and combinations thereof. A preferred fatty acid is a C₁₂ fatty acid.

Typically, when the modifying agent is a fatty acid, from about 0.25% (by weight dry basis soy protein curd) to about 1.5% (by weight dry basis soy protein curd) fatty acid is introduced into the neutralized soy protein curd suspension. More suitably, from about 0.5% (by weight dry basis soy protein curd) to about 1.5% (by weight dry basis soy protein curd) fatty acid is introduced into the neutralized soy protein curd suspension, and even more suitably, about 1.0% (by weight dry basis soy protein curd) fatty acid is introduced into the neutralized soy protein curd suspension.

In addition to the TGs, sucrose esters, and fatty acids, the modifying agent can suitably be a lecithin (phosphatidylcholine). Lecithin is a mixture of fatty substances that are derived from the processing of soybeans. Lecithin can be separated from soybean oil by conventional means including through the addition of water and centrifugation or steam precipitation. Specifically, soy lecithin comprises three types of phospoholipids: phosphatidylcholine, phosphatidylethanolamine, and phosphotidylinositol.

Soy lecithin for use in the present invention comprises an acetone soluble fraction and an acetone insoluble fraction. Suitably, the lecithin comprises an acetone insoluble fraction of from about 45% (by weight lecithin) to about 60% (by weight lecithin), more suitably from about 52% (by weight lecithin) to about 55% (by weight lecithin).

Lecithins have been used in foods and food products to date as an emulsifier, stabilizer, and antioxidant. For example, it has been used to promote solidity in margarine and to give consistent texture to dressings and other creamy products. Lecithin has also been used in chocolates and coatings and to counteract spattering during frying.

Typically, when the modifying agent is a lecithin, from about 0.25% (by weight dry basis soy protein curd) to about 1.5% (by weight dry basis soy protein curd) lecithin is introduced into the neutralized soy protein curd suspension. More suitably, from about 0.5% (by weight dry basis soy protein curd) to about 1.5% (by weight dry basis soy protein curd) lecithin is introduced into the neutralized soy protein curd suspension, and even more suitably, about 1.0% (by weight dry basis soy protein curd) lecithin is introduced into the neutralized soy protein curd suspension. Suitable soy lecithins for use in the present invention include, genetically modified and non-modified lecithins, for example, commercially available products such as ACTIFLO 68-UB, CENTROPHASE C, CENTROPHASE 152, CENTROPHASE F, CENTROPHASE HR-4B, CENTROLENE A, PRECEPT 8120, Centrocap 162USB, and STERNTHIL MB-58, which is non-genetically modified and identity preserved (IP) (The Solae Company, St. Louis, Mo.).

In an alternative embodiment, the modifying agent may be sodium hypochlorite. Sodium hypochlorite may act as a crosslinking agent when contacted with soy proteins, thereby modifying the structure of the soy proteins and improving various properties thereof. Although sodium hypochlorite can be used alone as a modifying agent, it is desirably used in combination with a sucrose ester, a fatty acid, or a lecithin.

Suitably, the processes of the present invention comprise introducing from about 0.25% (by weight dry basis soy protein curd) to about 1.5% (by weight dry basis soy protein curd) sodium hypochlorite into the neutralized soy protein curd suspension. More suitably, the processes of the present invention comprise introducing from about 0.5% (by weight dry basis soy protein curd) to about 1.5% (by weight dry basis soy protein curd) sodium hypochlorite into the neutralized soy protein curd suspension, and even more suitably, introducing about 1.0% (by weight dry basis soy protein curd) sodium hypochlorite into the neutralized soy protein curd suspension. As noted above, the sodium hypochlorite is depleted during the modification process of the soy proteins when used as a modifying agent. As such, the resulting soy protein isolate composition will not comprise sodium hypochlorite.

The processes for making the soy protein isolate compositions of the present invention further comprise a heat treatment. As noted above, heating can be carried out prior to, or after, the modifying agent has been introduced into the neutralized soy protein curd suspension. Generally, when heat treatment is carried out after introducing the modifying agent into the neutralized soy protein curd suspension, the heat treatment is conducted from about 15 minutes to about 30 minutes after the modifying agent is introduced into the neutralized soy protein curd suspension. When the heat treatment is carried out prior to introducing the modifying agent into the neutralized soy protein curd suspension, the heat treatment is conducted immediately after the pH of the neutralized soy protein curd suspension is raised by being contacted with the basic solution. The heat treatment modifies the protein structure in the soy protein curd suspension, allowing the soy proteins to interact differently with the modifying agents. Typically, the heat treatment comprises heating in a vacuum at a temperature of about 48.9-60° C. (120-140° F.) and a pressure of 500 psig for 9 to 15 seconds.

When the modifying agent is transglutaminase, the neutralized soy protein curd suspension can optionally be homogenized prior to adding the transglutaminase and heat treatment. Homogenization helps to uniformly disperse the proteins of the neutralized soy protein curd suspension, allowing for a more effective interaction between the neutralized soy protein curd suspension and the transglutaminase. Typically, homogenization is conducted at a homogenization pressure of about 1000 psig.

Finally, to produce the soy protein isolate compositions of the present invention, the heated modified soy protein curd suspension is dried. In one embodiment, the heated modified soy protein curd suspension can be dried by spray drying at a temperature of about 82° C. (180° F.). Alternatively, the heated modified soy protein curd suspension can be freeze dried, or dried in another conventional manner. Additionally, as noted above, when transglutaminase is used as the modifying agent, the transglutaminase is typically inactivated prior to the heated modified soy protein curd suspension being dried.

As a result of the above processes, a soy protein isolate composition suitable for use in meats and meat products is produced. In one embodiment, the soy protein isolate composition made by the processes of the present invention suitably comprises 98.5% (by weight dry basis) to about 99.75% (by weight dry basis) precipitated soy protein curd and from about 0.25% (by weight dry basis) to about 1.5% (by weight dry basis) modifying agent, wherein the precipitated soy protein curd comprises at least about 90% (by weight curd) soy protein, less than 1.0% (by weight curd) carbohydrates, from about 0.2% (by weight curd) to about 1.0% (by weight curd) fat, less than 5.0% (by weight curd) ash, and from about 3.0% (by weight curd) to about 6.0% (by weight curd) moisture.

As a result of the above processes, the soy protein isolate compositions of the present invention have an improved cooked gel strength. Having improved cooked gel strength will provide for a meat or other food product to have improved texture and bite. “Cooked gel strength” as used herein is a measure of the strength of a gel of a soy material following heating the material in boiling water for 30 minutes and then allowing the material to cool for 30 minutes under 27±5° C. tap water. One suitable method for measuring the cooked gel strength of a soy protein-containing composition includes: mixing 2315 grams tap water and 385 grams±0.1 gram soy protein isolate in a chopper bowl for 8 minutes to form a gel; removing 1300±5 grams of gel and filming four separate cans about ½ to about ¾ full of gel; to the remaining gel in the chopper bowl, resume chopping and add 28.0 grams of salt; filling four cans about ½ to about ¾ full with gel containing salt; tapping all eight cans on a hard surface to compress the gels. Once the gels are prepared, place 4 cans (2 with salt and 2 without salt) in a kettle containing rapidly boiling water and heat for 30 minutes. Immediately after heating is completed, remove the cans and allow them to cool for 30 minutes under 27±5° C. tap water. After cooling, place the cans in refrigerated storage for 16-24 hours. The cooked gel strength of the soy protein-containing gels is then measured using a TA.TXT2 Texture Analyzer, manufactured by Stable Micro Systems Ltd. (England).

Typically, cooked gel strength is evaluated in terms of grams. In one embodiment, cooked gel strength is measured in an environment substantially free of salt. In another embodiment, cooked gel strength is measured in an environment with 2% (by weight) salt. It is advantageous to have improved gel strength in an environment comprising salt as commercially available meats and meat products comprising the soy protein isolate compositions comprise 2% salt.

Cooked gel strength of the soy protein isolate composition of the present invention measured in an environment with 2% (by weight) salt has a value of at least about 3000 grams, more suitably of at least about 3200 grams, and even more suitably of at least about 3300 grams. Cooked gel strength of the soy protein isolate composition prepared by the processes of the present invention measured in an environment substantially free of salt has a value of at least about 2400 grams, more suitably of at least about 2700 grams, and even more suitably of at least about 3000 grams.

In addition to having improved cooked gel strength, the soy protein isolate compositions prepared by the processes of the present invention have improved emulsion strength. The emulsion strength of a soy protein-containing material measures the ability of the material to form an emulsion with water and oil. One suitable method for measuring emulsion strength is as follows: place 840 grams±0.1 gram of soybean oil into a 1,000 mL beaker; pour the oil into a chopper bowl and add 200 grams±0.1 gram of soy isolate sample into the bowl, spreading the sample over the entire surface of the oil; begin chopping the oil sample mixture; add 1,150 mL±10 mL of deionized water at a temperature of 20±3° C. and resume chopping; fill three 5.0 ounce plastic cups with emulsion sample. The samples are then refrigerated for 30 hours at a temperature of 4±2° C. After refrigeration, determine the emulsion strength using a TA.TXT2 Texture Analyzer (available from Stable Micro Systems Ltd., England). Emulsion strength is generally expressed in terms of grams.

Suitably, the soy protein isolate compositions produced in the processes of the present invention will have an emulsion strength of at least about 150 grams. More suitably, the soy protein isolate compositions produced in the processes of the present invention will have an emulsion strength of at least about 170 grams.

The soy protein isolate compositions produced in the processes of the present invention additionally have improved cooked emulsion stability. As used herein, the term “cooked emulsion stability” means the ability of a soy protein-containing material to form a stable emulsion with water and oil after being cooked. The emulsion samples are prepared similar to the emulsion samples used in determining emulsion strength as discussed above. To determine the emulsion stability of the samples, the following method may be used: the samples are cooked in boiling water for 30 minutes and then placed into an ice water bath for 15 minutes±2 minutes; refrigerate the cooked samples for at least 20 hours, but no more than 32 hours, at a temperature of 5±2° C. After refrigeration, the samples are removed from the cups and cut in half longitudinally. Each half is weighed. The halves are then placed in a preheated skillet at 30 second intervals and fried for 10 minutes. Each half is then removed from the skillet and weighed. Emulsion stability of the samples is determined using the following formula:
Emulsion Stability=(Initial Weight−Final Weight)/Initial Weight×100

Typically, cooked emulsion stability is measured in terms of the percentage of weight loss from the initial weight of the sample to the final weight of the sample. As such, a smaller amount of weight loss indicates a more stable sample.

Suitably, the soy protein isolate compositions of the present invention have a cooked emulsion stability of about 5.2%. More suitably, the soy protein isolate compositions of the present invention have a cooked emulsion stability of about 5.0%, and even more suitably of about 4.8%.

The soy protein isolate compositions prepared by the processes of the present invention have improved solubility in water. Solubility of the proteins contained in the soy protein isolate composition is generally determined by preparing an aqueous dispersion of the soy protein isolate composition containing a known quantity of protein, centrifuging the composition to produce a centrifugate, and analyzing the centrifugate to determine its protein content. The amount of protein present in the centrifugate may be determined using various methods generally known in the art and may be determined using a UV-Spectrophotometer. Such methods include, for example, A.O.C.S. (American Oil Chemists' Society) Official Methods Ba 11-65, Revised (1969), Bc 4-91(1997), Aa 5-91(1997), or Ba 4d-90(1997).

In accordance with the present invention, at a pH of 7.0 and a temperature of about 25° C., typically at least about 90% of the soy proteins remain in solution after centrifuging the sample, more typically at least about 92% and, still more typically, at least about 95%.

The solubility of the proteins may also be expressed in terms of the Nitrogen Solubility Index (NSI). NSI as used herein is defined as:
NSI=(% water soluble nitrogen of a protein containing sample/% total nitrogen in protein containing sample)×100.

The NSI provides a measure of the percent of water soluble protein relative to total protein in a protein containing material. The NSI of a soy protein material is measured in accordance with standard analytical methods, specifically A.O.C.S. Method Ba 11-65, which is incorporated herein by reference in its entirety. According to the Method Ba 11-65, a soy material sample (5 grams) ground fine enough so that at least 95% of the sample will pass through a U.S. grade 100 mesh screen (average particle size of less than about 150 microns) is suspended in distilled water (200 ml), with stirring at 120 revolutions per minute (rpm), at 30° C. for two hours; the sample is then diluted to 250 milliliters with additional distilled water. If the soy material is a full-fat material the sample need only be ground fine enough so that at least 80% of the material will pass through a U.S. grade 80 mesh screen (approximately 175 μm), and 90% will pass through a U.S. grade 60 mesh screen (approximately 205 μm). Dry ice should be added to the soy material sample during grinding to prevent denaturation of the sample. Sample extract (40 ml) is decanted and centrifuged for 10 minutes at 1500 rpm, and an aliquot of the supernatant is analyzed for Kjeldahl protein (PRKR) to determine the percent of water soluble nitrogen in the soy material sample according to A.O.C.S Official Methods Bc 4-91 (1997), Ba 4d-90, or Aa 5-91, each hereby incorporated by reference in their entirety. A separate portion of the soy material sample is analyzed for total protein by the PRKR method to determine the total nitrogen in the sample. The resulting values of Percent Water Soluble Nitrogen and Percent Total Nitrogen are utilized in the formula above to calculate the nitrogen solubility index.

Typically, the soy protein-containing compositions of the present invention have a Nitrogen Solubility Index of at least about 90%, more typically at least about 92% and, still more typically, at least about 95%.

Additionally, the soy protein isolate compositions have an improved salt tolerance index. As used herein, the term “salt tolerance index” means the dispersible nitrogen content (expressed as protein) of a soy-containing material in the presence of salt. The salt tolerance index measures the solubility of protein in water in the presence of salt.

The salt tolerance index of the soy protein isolate compositions described herein may be determined utilizing the following method: 0.75 grams of sodium chloride is weighed and added to a 400-milliliter beaker. One hundred fifty milliliters of water at 30° C. is added to the beaker, and the salt is dissolved completely in the water. The salt solution is added to a mixing chamber, and 5 grams of a soy material sample is added to the salt solution in the mixing chamber. The sample and salt solution are blended for 5 minutes at 7000 revolutions per minute (rpm). The resulting slurry is transferred to a 400-milliliter beaker, and 50 milliliters of water is used to rinse the mixing chamber. The 50-milliliter rinse is added to the slurry. The beaker of the slurry is placed in 30° C. water bath and is stirred at 120 rpm for a period of 60 minutes. The contents of the beaker are then quantitatively transferred to a 250-milliliter volumetric flask using deionized water. The slurry is diluted to 250 milliliters with deionized water, and the contents of the flask are mixed thoroughly by inverting the flask several times. Forty-five milliliters of slurry are transferred to a 50-milliliter centrifuge tube and the slurry is centrifuged for 10 minutes at 500×g. The supernatant is filtered from the centrifuge tube through filter paper into a 100-milliliter beaker. Protein content analysis is then performed on the filtrate and on the original dry soy material sample according to A.O.C.S. Official Methods Bc4-91 (1997), Ba 4d-90, or Aa 5-91. The salt tolerance index (STI) is then calculated according to the following formula:
STI(%)=100×50×[(Percent soluble protein (in filtrate))/(Percent total protein (of dry soy protein-containing material))]

Typically, the soy protein isolate composition produced by the processes of the present invention has a STI of at least about 85%. More typically, the soy protein isolate composition of the present invention has a STI of at least about 90%.

In addition to the improved solubility and salt tolerance, the soy protein isolate composition produced by the processes of the present invention can have an increased or reduced viscosity. Lower viscosity soy protein isolate compositions may be intended for use in liquid products (i.e., beverages); and additionally, in some embodiments, lower viscosity soy protein isolate compositions may be desired for use in a meat product. As shown below, lower viscosity soy protein isolate compositions allow for improved water holding capacity of the meat product comprising the composition. Higher viscosity compositions may also be desired when the intended applications for the composition include incorporation into a meat product.

As noted above, the soy protein isolate composition can be heat treated (e.g., heated to a temperature of 48.9-60° C. (from 120-140° F.) for a period of from 9 to 15 seconds) prior to and/or after the modifying agent is introduced into the neutralized soy protein curd suspension. In certain embodiments, heat treatment after the modifying agent is introduced provides soy protein isolate compositions having higher viscosity than heat treated compositions without a modifying agent. As used herein, the term “viscosity” means the apparent viscosity of aqueous slurry or a solution as measured with a rotating spindle viscometer utilizing a large annulus, where a particularly preferred rotating spindly viscometer is a Brookfield viscometer. In another embodiment, the viscosity can be measured using a Rapid Visco Analyzer (RVA) viscometer.

In addition to having the improvements above, the soy protein isolate compositions produced by the processes of the present invention have improved translucency. Generally, an improved translucency allows a meat or meat product comprising the soy protein isolate composition to maintain its natural meat color. The translucency of a soy protein-containing sample is indicated as the percentage of light at certain wavelengths passing through a small gelled soy protein sample (i.e., percent transmittance). One suitable method for measuring translucency is as follows: 20 grams of a soy protein-containing sample is placed in an inverted frustoconical container having a capacity of approximately 205 mL; 180 mL of deionized water is introduced to a small blender jar; the sample is then slowly blended into the water to form a slurry; the slurry is transferred to a 50 mL Nalgene centrifuge tube and placed in a water bath that has been pre-heated to 97° C. and left for 45 minutes. The hot samples are then placed on translucent microscope slides (Fisherbrand, Colorfrost) and labeled. The samples are allowed to cool on the slides for at least 1 hour. To analyze the translucency of the samples, a Backman spectrophotometer (DU 640) is employed at wavelengths of 400 nm and 800 nm.

Typically, an aqueous dispersion of the soy protein isolate compositions produced in the present invention exhibits a percent transmittance at 800 nanometers (nm) of at least about 60%. More suitably, such a dispersion exhibits a percent transmittance at 800 nm of at least about 65%, even more suitably from 65% to about 70%.

### EXAMPLE

The following examples are simply intended to further illustrate and explain the present invention. The invention, therefore, should not be limited to any of the details in these examples.

### Example 1

In this Example, samples of soy protein isolate compositions comprising various modifying agents are produced. The functional properties of the compositions, such as gel strength, emulsion strength, emulsion stability, and solubility, are evaluated.

To obtain the soy protein isolates, ground identity preserved (IP) soy flakes are defatted with hexane and extracted at a pH of about 9.67 using sodium hydroxide (NaOH) as discussed herein above. Once the soy protein is extracted, it is suspended in water having a temperature of 96° F. (36° C.) for a period of 10 minutes. Hydrochloric acid (HCl) is then added to the suspended soy protein, lowering the pH of the suspension to about 4.45. The extract remains in the HCl solution for a period of 5 minutes to form a precipitated soy protein curd from the suspended soy protein. The precipitation separates the soy protein curd from the remaining carbohydrates and fats in the suspended soy protein. Separation is completed by centrifuging the precipitate in a Decanter centrifuge (available from Sharples Co., North Attleboro, Mass.) at a speed of 4000 revolutions per minute (rpm) and at a temperature of 96° F. (36° C.) for about 10 to about 15 seconds.

A second suspension process similar to the first suspension is performed to further remove impurities from the precipitated soy protein curd. Water (at 96° F. (36° C.)) is added to the curd at a water:curd ratio of 6:1. Again, the resultant suspended soy protein is centrifuged to complete separation of the precipitated soy protein curd from carbohydrates and fat. The centrifuging is performed at a temperature of 96° F. (36° C.) and at a speed of 4200 rpm for about 10 to about 15 seconds.

The resultant precipitated soy protein curd is then hydrated in a water solution and placed in a Cowles tank. Sodium hydroxide is added to the precipitated soy protein curd suspension to form a neutralized soy protein curd suspension having an increased pH. Sodium hydroxide is mixed with the soy protein solution for 10 minutes, raising the pH of the second solution to about 6.8.

Four samples of soy protein isolate composition comprising various modifying agents are made. Three samples are made by adding a sucrose ester, transglutaminase (TG), or a combination thereof to the neutralized soy protein curd suspension prior to the heat treatment described below. The sample comprising a combination of a sucrose ester and TG is produced by adding the sucrose ester prior to homogenizing the sample at a pressure of 1000 psig and then adding the TG after homogenization of the sample. The remaining sample was a control, and as such, no modifying agent is added to the curd suspension.

Heat treatment consists of heating the samples in an oven at 124° F. (51.1° C.) for 9 seconds. The types of modifying agent, concentrations of agents, and their points of addition to the neutralized soy protein curd suspension are shown in Table 1:

TABLE 1

| | Amount of | | |
|---|---|---|---|
| | Modifying Agent | | |
| Modifying Agent | (% by weight | | Time added |
| to be used in | dry basis soy | | (pre or post |
| composition | protein curd) | Source | heat treatment) |
| C₁₂ Sucrose | 1.0% | Mitsubishi- | Pre heat |
| Ester | | Kagaku Foods | |
| | | Corp. | |
| Transglutaminase | 0.4% | Ajinomoto | Pre heat |
| | | USA Inc. | |
| C₁₂ Sucrose | 1.0% Sucrose | Mitsubishi- | Pre heat |
| Ester + Transglu- | Ester + | Kagaku Foods | |
| taminase (TG) | 0.4% Transglu- | Corp. and | |
| | taminase | Ajinomoto | |
| | | USA Inc. | |
| Control | N/A | The Solae Co. | N/A |

N/A = Not Applicable

Finally, the mixtures are dried by spray drying at a temperature of 180° F. (82° C.) to form soy protein isolate compositions comprising various types of modifying agents.

The cooked gel strengths of the soy protein isolate compositions made by adding the modifying agents prior to heat treatment are measured. The cooked gel strengths of the soy protein isolate compositions are tested in an environment comprising 2% (by weight) salt and in an environment free of salt. Cooked gel strength is measured by cooking the composition samples for 30 minutes in steam at a temperature of 218° F. (100° C.). The cooked gel strength is then measured by an Instron analyzer (available from Instron Corporation, Canton, Me.).

Additionally, the soy protein isolate compositions are tested for cooked emulsion strength using a TA.TXT2 Texture Analyzer (available from Stable Micro Systems Ltd., England) and cooked emulsion stability using the methods as discussed herein above. The results of these measurements are shown in Table 2 below:

TABLE 2

| | Cooked Gel | Cooked Gel | | Emulsion |
|---|---|---|---|---|
| Modifying | Strength | Strength | Emulsion | Stability |
| agent used in | (with 2% | (without | Strength | (% weight |
| composition | salt) (g) | salt) (g) | (g) | loss) |
| 1.0% C₁₂ Sucrose | 1730 | 980 | 129 | 5.6 |
| Ester | | | | |
| 0.4% TG | 3340 | 2550 | 153 | 5.8 |
| 1.0% C₁₂ Sucrose | 3270 | 3000 | 170 | 4.8 |
| Ester + 0.4% TG | | | | |
| Control | 1780 | 1150 | 111 | 6.1 |

The data in Table 2 show that pre heat addition of 0.4% TG increases cooked gel strength in the presence of 2% salt by 88% compared to the control. Additionally, pre heat addition of 1.0% C12 Fatty Acid Sucrose Ester in combination with 0.4% TG increases cooked gel strength in the presence of 2% salt by 84% compared to the control. In an environment free of salt, the pre heat addition of TG alone and in combination with C12 Fatty Acid Sucrose Ester increase cooked gel strength by about 122% and about 161%, respectively.

Additionally, as shown in Table 2, pre heat addition of 1.0% C12 Fatty Acid Sucrose Ester alone and 0.4% TG alone increase emulsion strength of the soy protein isolate composition by 16% and 38% respectively compared to the control. While the addition of 1.0% C12 Fatty Acid Sucrose Ester alone and 0.4% TG alone increased emulsion strength, the greatest increase in emulsion strength is shown with the pre heat addition of 1.0% C12 Fatty Acid Sucrose Ester/0.4% TG combination, which increases emulsion strength of the soy protein isolate composition by 53% compared to the control.

As noted above, when discussing cooked emulsion stability, the smaller the percentage of weight loss, the more stable the emulsion. As such, as shown in Table 2, all three samples containing modifying agents improve cooked emulsion stability. Specifically, the pre heat addition of 1.0% C₁₂ Fatty Acid Sucrose Ester has an emulsion stability of 5.6% as compared to the control, which has an emulsion stability of 6.1%. The pre heat addition of 0.4% TG has an emulsion stability of 5.8% compared to the control's 6.1%. While the addition of 1.0% C12 Fatty Acid Sucrose Ester alone and 0.4% TG alone increased emulsion stability, the greatest increase in emulsion stability is shown with the pre heat addition of 1.0% C12 Fatty Acid Sucrose Ester/0.4% TG combination, which has an emulsion stability of 4.8% compared to the control's 6.1%.

In a corresponding example, the functional properties of soy protein isolate compositions comprising additional modifying agents are tested. Specifically, the corresponding example employs five samples: (1) a control sample containing no added modifying agent; (2) a sample comprising 1.0% (by weight dry basis soy protein curd) C₁₂ Fatty Acid (available from Acme-Hardsty Co.) added after heat treatment; (3) a sample comprising 1.0% (by weight dry basis soy protein curd) C₁₂ Sucrose Ester (available from Mitsubishi-Kagaku Foods Corp.) added after heat treatment; (4) a sample comprising 0.3% (by weight dry basis soy protein curd) TG (available from Ajinomoto USA Inc.) added after heat treatment; and (5) a sample comprising a combination of 1.0% (by weight dry basis soy protein curd) C₁₂ Fatty Acid and 0.3% (by weight dry basis) TG added after heat treatment.

In this corresponding sample, the soy protein isolate composition comprising 0.3% (by weight dry basis soy protein curd) TG and the composition comprising 1.0% (by weight dry basis soy protein curd) C₁₂ Fatty Acid in combination with 0.3% (by weight dry basis soy protein curd) TG improve cooked gel strength by 27% and 43% respectively compared to the control. However, post heat additions of C₁₂ Fatty Acid and C₁₂ Fatty Acid Sucrose Ester alone decrease cooked gel strength of the soy protein isolate compositions by about 12% to 17%. Additionally, the soy protein isolate composition comprising 1.0% (by weight dry basis soy protein curd) C₁₂ Fatty Acid in combination with 0.3% (by weight dry basis soy protein curd) TG added post heat treatment improves cooked emulsion strength by 7% compared to the control. Post heat additions of C₁₂ Fatty Acid, C₁₂ Fatty Acid Sucrose Ester, and TG alone decrease cooked emulsion strength. Finally, all of the samples treated with modifying agents post heat treatment improve cooked emulsion stability. Specifically, the soy protein isolate compositions comprising C₁₂ Fatty Acid, C₁₂ Fatty Acid Sucrose Ester, and TG alone improve emulsion stability by 1%, 7%, and 17% respectively compared to the control. Similar to the Example 1 above, while the addition of C₁₂ Fatty Acid, C₁₂ Fatty Acid Sucrose Ester, and TG alone increased emulsion stability, the greatest increase in emulsion stability is shown with the pre heat addition of 1.0% C₁₂ Fatty Acid Sucrose Ester/0.4% TG combination, which improves cooked emulsion stability by 24% (i.e., 24% less weight was lost) compared to the control.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “by weight” is used throughout the application to describe the amounts of components in the soy protein isolate composition. Unless otherwise specified, the term “by weight” is intended to mean by weight on an as is basis, without any moisture added or removed from the product. The term by weight dry basis is intended to mean on a moisture-free basis, in which the moisture has been removed.

As various changes could be made in the above without departing from the scope of the invention, it is intended that all matter contained in the above description and shown in the accompanying drawings shall be interpreted as illustrative and not in a limiting sense.

What is claimed is:

1. A process for producing a soy protein isolate composition, the process comprising:
extracting a soy protein from defatted soy flakes with an aqueous alkaline wash having a pH of from 8.5 to about 10;
suspending the extracted soy protein in a wash solution comprising water;
contacting the suspended soy protein with an acid to form a precipitated soy protein curd;
contacting the precipitated soy protein curd with a hydrating solution comprising water to form a precipitated soy protein curd suspension;
contacting the precipitated soy protein curd suspension with a basic solution to form a neutralized soy protein curd suspension;
introducing a modifying agent into the neutralized soy protein curd suspension to form a modified soy protein curd suspension, wherein the modifying agent is selected from the group consisting of transglutaminase, sodium hypochlorite, a sucrose ester, a fatty acid, a lecithin, and combinations thereof;
heating the modified soy protein curd suspension; and
drying the heated modified soy protein curd suspension to form a soy protein isolate composition.

2. The process as set forth in claim 1 wherein the aqueous alkaline wash for extracting the soy protein comprises a base selected from the group consisting of sodium hydroxide, potassium hydroxide, ammonium hydroxide, and calcium hydroxide.

3. The process as set forth in claim 1 wherein the modifying agent is introduced into the neutralized soy protein curd suspension in an amount of from about 0.25% (by weight dry basis soy protein curd) to about 1.5% (by weight dry basis soy protein curd).

4. The process as set forth in claim 1 wherein the soy protein isolate composition comprises from about 98.5% (by weight dry basis) to about 99.75% (by weight dry basis) precipitated soy protein curd and from about 0.25% (by weight dry basis) to about 1.5% (by weight dry basis) modifying agent, wherein the precipitated soy protein curd comprises at least about 90% (by weight curd) soy protein, less than 1.0% (by weight curd) carbohydrates, from about 0.2% (by weight curd) to about 1.0% (by weight curd) fat, less than 5.0% (by weight curd) ash, and from about 3.0% (by weight curd) to about 6.0% (by weight curd) moisture.

5. The process as set forth in claim 4 wherein the modifying agent is transglutaminase that is present in the soy protein isolate composition in an amount of from about 0.3% (by weight dry basis) to about 0.4% (by weight dry basis).

6. The process as set forth in claim 5 wherein the neutralized soy protein curd suspension is homogenized prior to introducing the transglutaminase.

7. The process as set forth in claim 5 wherein the transglutaminase is inactivated prior to drying the heated modified soy protein curd suspension.

8. The process as set forth in claim 1 wherein the soy protein isolate composition has a cooked gel strength measured in an environment comprising about 2% (by weight) salt of at least about 3000 grams.

9. The process as set forth in claim 1 wherein the soy protein isolate composition has a cooked emulsion strength of at least about 150 grams.

10. The process as set forth in claim 1 wherein the soy protein isolate composition has a cooked emulsion stability of about 5.2%.

11. A process for producing a soy protein isolate composition, the process comprising:
extracting a soy protein from defatted soy flakes with an aqueous alkaline wash having a pH of from 8.5 to about 10;
suspending the extracted soy protein in a wash solution comprising water;
contacting the suspended soy protein with an acid to form a precipitated soy protein curd;
contacting the precipitated soy protein curd with a hydrating solution comprising water to form a precipitated soy protein curd suspension;
contacting the precipitated soy protein curd suspension with a basic solution to form a neutralized soy protein curd suspension;
heating the neutralized soy protein curd suspension;
introducing a modifying agent to the heated neutralized soy protein curd suspension to form a heated modified soy protein curd suspension, wherein the modifying agent is selected from the group consisting of transglutaminase, sodium hypochlorite, a sucrose ester, a fatty acid, a lecithin, and combinations thereof; and
drying the heated modified soy protein curd suspension to form a soy protein isolate composition.

12. The process as set forth in claim 11 wherein the aqueous alkaline wash for extracting the soy protein comprises a base selected from the group consisting of sodium hydroxide, potassium hydroxide, ammonium hydroxide, and calcium hydroxide.

13. The process as set forth in claim 11 wherein the modifying agent is introduced into the heated neutralized soy protein curd suspension in an amount of from about 0.25% (by weight dry basis soy protein curd) to about 1.5% (by weight dry basis soy protein curd).

14. The process as set forth in claim 11 wherein the soy protein isolate composition comprises from about 98.5% (by weight dry basis) to about 99.75% (by weight dry basis) precipitated soy protein curd and from about 0.25% (by weight dry basis) to about 1.5% (by weight dry basis) modifying agent, wherein the precipitated soy protein curd comprises at least about 90% (by weight curd) soy protein, less than 1.0% (by weight curd) carbohydrates, from about 0.2% (by weight curd) to about 1.0% (by weight curd) fat, less than 5.0% (by weight curd) ash, and from about 3.0% (by weight curd) to about 6.0% (by weight curd) moisture.

15. The process as set forth in claim 14 wherein the modifying agent is transglutaminase that is present in the soy protein isolate composition in an amount of from about 0.3% (by weight dry basis) to about 0.4% (by weight dry basis).

16. The process as set forth in claim 15 wherein the neutralized soy protein curd suspension is homogenized prior to introducing the transglutaminase.

17. The process as set forth in claim 15 wherein the transglutaminase is inactivated prior to drying the heated modified soy protein curd suspension.

18. The process as set forth in claim 11 wherein the soy protein isolate composition has a cooked gel strength measured in an environment comprising about 2% (by weight) salt of at least about 3000 grams.

19. The process as set forth in claim 11 wherein the soy protein isolate composition has a cooked emulsion strength of at least about 150 grams.

20. The process as set forth in claim 11 wherein the soy protein isolate composition has a cooked emulsion stability of about 5.2%.
